(19) United States
(12) Patent Application Publication
(10) Pub. No.: US 2012/0330859 A1
(43) Pub. Date: Dec. 27, 2012

(54) INTERACTIVE BUSINESS PROCESS MODELING AND SIMULATION

(75) Inventors: Chang Rui Ren, Beijing (CN); Ajay Satsangi, Charlotte, NC (US); Qin Hua Wang, Beijing (CN)

(73) Assignee: INTERNATIONAL BUSINESS MACHINES CORPORATION, Armonk, NY (US)

(21) Appl. No.: 13/169,126

(22) Filed: Jun. 27, 2011

(51) Int. Cl. G06Q 10/00

(52) U.S. Cl. 705/348

(57) ABSTRACT

Interactive business process modeling and simulation includes generating a business process model including mapping business processes with activities, logical gates, and decision paths of an enterprise. The interactive business process modeling and simulation also includes creating a business process simulation model by assigning a transaction to corresponding activities for business processes in the business process model, the business process simulation model including at least one entry transaction and transaction sequence for each of the activities. The interactive business process modeling and simulation further includes executing the business process simulation model by calling the entry transaction and displaying the entry transaction, loading input data and intermediate data into the business process simulation model, and executing transactions starting with the entry transaction and using the intermediate data and an output from execution of the entry transaction to feed a next one of the transactions configured by the business process simulation model.

### BACKGROUND

The present invention relates to business process modeling and simulation, and more specifically, to interactive business process modeling and simulation based on an enterprise system.

Business process simulation is one of the most popular techniques in business process analysis and reengineering. It is also one of the most intuitive and effective methods in end user training for an enterprise system. In traditional business process simulation, animated pictures of the business processes and/or real time fluctuations in the key performance measures are used for intuitive illustration. However, this animation may not be sufficient for enterprise system implementation and training, as traditional simulation methods do not display how real processes are executed in the enterprise system. Further, traditional simulation methods are not able to perform process verification to ensure processes can be reliably executed by the enterprise system.

### SUMMARY

According to one embodiment of the present invention, a method for interactive business process modeling and simulation includes generating a business process model including mapping business processes with activities, logical gates, and decision paths of an enterprise. The method also includes creating a business process simulation model by assigning a transaction to each of corresponding activities for each of the business processes in the business process model, via a user interface implemented by a computer processor, the business process simulation model including at least one entry transaction and transaction sequence for each of the activities. The method further includes executing the business process simulation model via a simulation engine communicatively coupled to the computer processor. The business process simulation model execution including calling the entry transaction and displaying the entry transaction, loading input data and intermediate data into the business process simulation model, and executing transactions starting with the entry transaction and using the intermediate data and an output from execution of the entry transaction to feed a next one of the transactions configured by the business process simulation model.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which interactive business process modeling and simulation processes may be implemented in accordance with an exemplary embodiment; and

FIGS. 2A-2B depict a flow diagram of a process for implementing interactive business process modeling and simulation processes in an exemplary embodiment.

### DETAILED DESCRIPTION

The interactive business process modeling and simulation processes provide a business process simulation that is integrated with an enterprise system, such that when one business process task or activity is triggered in the simulation process, corresponding functions or transactions of the enterprise system are called remotely and are displayed for a system user. Input data associated with the transactions may be automatically entered by the interactive business process modeling and simulation processes, or may be entered by the user prior to execution of the transactions via user interface of the interactive business process modeling and simulation processes. Output data may be used as input data for the next process task or activity.

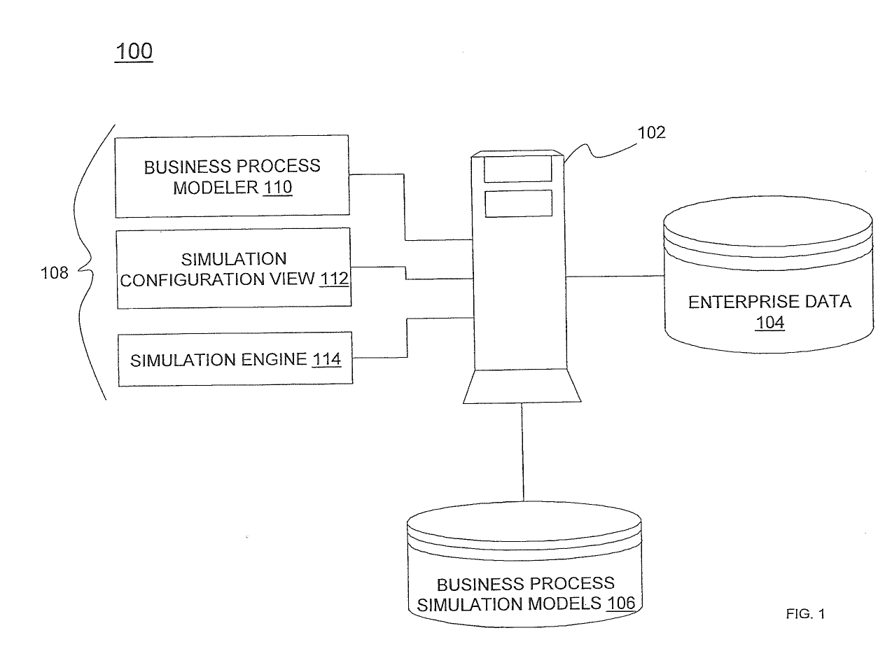

With reference now to FIG. 1, a system upon which interactive business process modeling and simulation processes may be implemented in an exemplary embodiment will now be described. The system 100 includes an enterprise host system 102 in communication with a storage device 104. The enterprise host system 102 represents a business enterprise that is implementing the exemplary interactive business process modeling and simulation processes. For example, the business enterprise may be any commercial or non-profit entity that conducts a variety of transactions and manages a variety of data in support of its operations. The enterprise host system 102 (also referred to herein as “host system” 102) may be implemented as a high-speed computer processing device (e.g., a mainframe computer) that is capable of handling a large volume of transactions and communications on behalf of the enterprise.

The storage device 104 includes a data repository with data relating to managing the interactive business process modeling and simulation processes and may be implemented using a variety of devices for storing electronic information. It is understood that the storage device 104 may be implemented using memory contained in the host system 102 or that it may be a separate physical device (e.g., as shown in FIG. 1). The storage device 104 is logically addressable as a consolidated data source across a distributed environment that may include one or more networks (not shown). Information stored in the storage device 104 may be retrieved and manipulated via the host system 102. The data repository includes one or more databases containing documents, files, and related data in support of the interactive business process modeling and simulation processes.

In an exemplary embodiment, the host system 102 executes one or more applications in support of the interactive business process modeling and simulation processes. These applications are collectively referred to as interactive business process modeling and simulation application 108 and include a business process modeler module 110, a simulation configuration view module 112, and a simulation engine module 114. The host system 102 may include a display device for displaying animations created by the interactive business process modeling and simulation processes.

In an embodiment, the business process modeler module 110 maps business processes with activities, logical gates, decision parts, etc. to create a business process model.

In an embodiment, the simulation configuration view module 112 includes a user interface configured to enable users to add, delete, and edit transaction attributes and traditional parameters for activities. In particular, the simulation configuration view module 112 assigns transactions for each activity that will execute in the enterprise system. The simulation configuration view module 112 also specifies an entry transaction and transaction sequence for each activity, assigns initial input data for the transaction, and assigns data format and input data resources for each transaction. The entry transaction refers to an initial transaction in a series of transactions assigned to an activity. The initial input data refers to the first data input in the simulation process for a transaction. The simulation configuration view module 112 further specifies operational data that should be analyzed.

In an embodiment, the simulation engine module 114 calls transactions according to the simulation progress, loads input data for transaction, displays and runs the transactions, captures operational data when the transactions are running, and verifies processes for future deployment.

In an exemplary embodiment, the interactive business process modeling and simulation processes generate a business process simulation model via the business process modeler module 110 and stores the business process simulation model in a database 106 that is communicatively coupled to the host system 102.

In an exemplary embodiment, the interactive business process modeling and simulation processes display actual process execution details associated with the business enterprise in conjunction with animation reflecting the process execution. In addition, the business processes may be verified before their deployment. For example, if the enterprise system is not developed or configured according to the business processes, the simulation may not be successfully completed. The interactive business process modeling and simulation processes may verify reengineered business processes prior to their deployment. In addition, the interactive business process modeling and simulation processes ensure transparency of the simulation output. Output data and intermediate data that are created by each transaction may be displayed in the simulation system or in the enterprise system. The interactive business process modeling and simulation processes may also be configured to be compatible with traditional simulation methods.

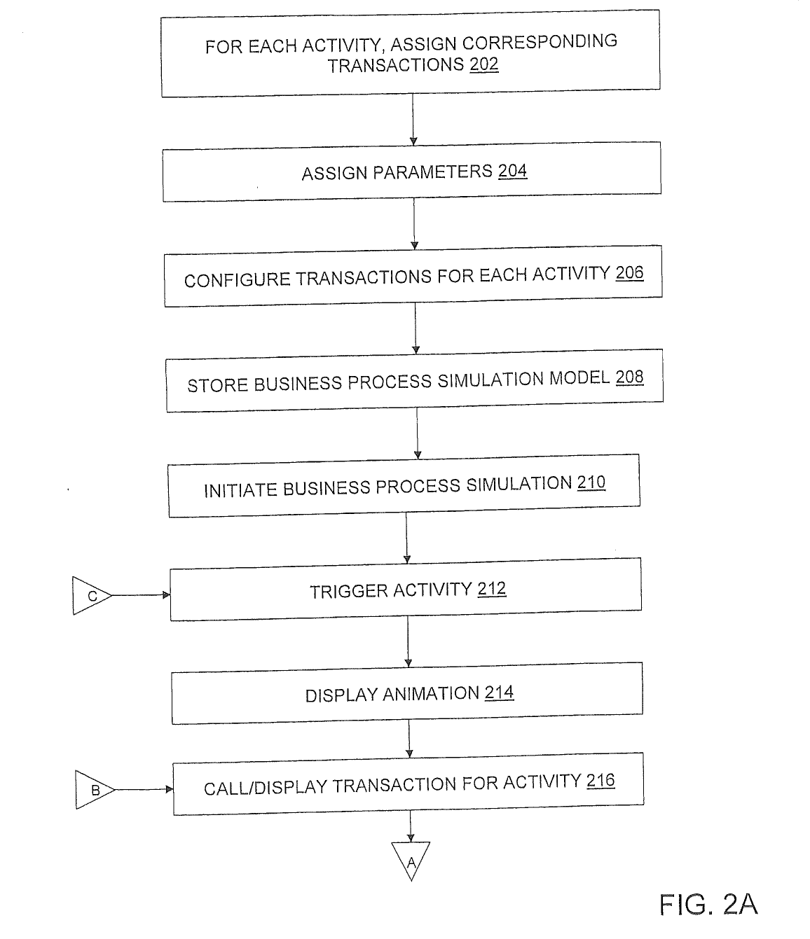

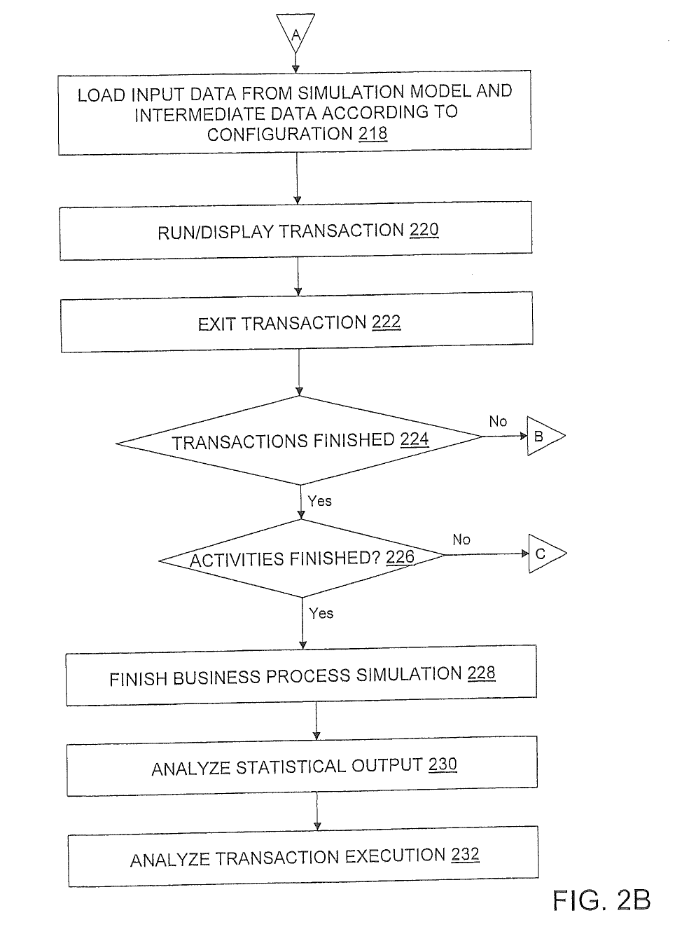

Turning now to FIG. 2, an exemplary process for implementing the interactive business process modeling and simulation processes will now be described. Steps 200-208 relate to generating a business process simulation model, and steps 210-232 relate to performing business process simulation using the model created in steps 200-208.

In an embodiment, at step 200 the business process modeler module 110 maps business processes of the enterprise with corresponding process activities, logical gates, decision parts, etc. and creates a business process model therefrom. At step 202, for each activity that will execute in the enterprise system, the simulation configuration view module 112 assigns corresponding transactions to the process activities. For example, in the business process model, each activity represents an object, which in turn contains one or more attributes. Some attributes may be simple values, such as a string or an integer, and other attributes may be complex objects. When assigning transactions to an activity, the transactions may be set as complex attributes of the activity.

At step 204, the simulation configuration view module 112 assigns traditional parameters to each of the activities. The traditional parameters may also be attributes of the activity (object). For example, a traditional parameter may be resource consumption of the activity.

At step 206, the simulation configuration view module 112 customizes the simulation process through configuring transactions for each activity. For example, as indicated above, the simulation configuration view module 112 includes a user interface, which is used to add, delete and edit the transaction attributes and traditional parameters of the activity object.

At step 208, a business process simulation model is created from the processes performed in steps 200-206 and is stored, e.g., in storage device 106.

At step 210, the business process simulation is initiated for the model, which triggers an activity in the business process simulation model at step 212. The activity may be triggered by a token that is automatically generated by the simulation engine 114 for each simulation instance when the simulation process is started. The initial position of the token is at the start point of the simulation process (step 210). The simulation of an activity may be triggered when the token arrives at the activity during the simulation process. The token leaves the activity when the activity's simulation is finished. The token's route through the simulation process may be determined by the logical gateways defined in the business process model.

At step 214, animation is displayed, e.g., at the host system 102 that reflects the flow of the process simulation with respect to the triggered activity.

At step 216, the simulation engine module 114 calls and displays a transaction (e.g., the entry transaction) corresponding to the activity (e.g., via the host system 102). A transaction may be called by sending a command to the application 108 to execute the transaction. In the enterprise system, each transaction may have its own user interface. When the transaction is being executed, its user interface is displayed, which illustrates the corresponding user actions (e.g., inputting data for the transaction) and execution results of the transaction.

At step 218, the simulation engine module 114 loads input data from data sources, such as the business process model and enterprise data in the storage device 104, as well as any intermediate data determined from the simulation execution. For example, if the input data is a variable defined in the business process simulation model, then the simulation engine 114 may be configured to directly apply the input data into the simulation process. If the data are saved in a repository (e.g., the storage device 104), then the input data may be loaded into the business process simulation model and then applied into the simulation process by the simulation engine 114. The data source may be a file on a hard disk or a table in the enterprise system's database, etc.

At step 220, the simulation engine module 114 runs and displays the transaction (e.g., via the host system 102). At step 222, the transaction is completed and exited.

At step 224, the interactive business process modeling and simulation processes determine if there are any other transactions associated with this activity. If so, the process returns to step 216, and another transaction is called displayed.

Otherwise, if there are no other transactions for this activity, the interactive business process modeling and simulation processes determine whether all activities for the business process simulation model have been triggered at step 226. If not, the process returns to step 212. The business process simulation model may be stored in the storage device 106.

Otherwise, business process simulation is completed at step 228, statistical output and analysis is performed by the simulation engine module 114 at step 230, and transaction execution analysis is implemented at step 232.

Technical effects of the interactive business process modeling and simulation processes include a business process simulation that is integrated with an enterprise system, such that when one business process task or activity is triggered in the simulation process, corresponding functions or transactions of the enterprise system are called remotely and are displayed for a system user. Input data associated with the transactions may be automatically entered by the interactive business process modeling and simulation processes, or may be entered by the user prior to execution of the transactions. Output data may be used as input data for the next process task or activity.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
generating a business process model including mapping business processes with activities, logical gates, and decision paths of an enterprise;
creating a business process simulation model by assigning a transaction to each of corresponding activities for each of the business processes in the business process model, via a user interface implemented by a computer processor, the business process simulation model including at least one entry transaction and transaction sequence for each of the activities;
executing the business process simulation model via a simulation engine communicatively coupled to the computer processor, comprising:
calling the entry transaction and displaying the entry transaction;
loading input data and intermediate data into the business process simulation model; and
executing transactions starting with the entry transaction and using the intermediate data and an output from execution of the entry transaction to feed a next one of the transactions configured by the business process simulation model.

2. The method of claim 1, wherein executing the business process simulation model further includes triggering simulation of an activity via a token positioned at a beginning of the business process simulation model.

3. The method of claim 1, further comprising displaying animation of business process simulation model execution on a display communicatively coupled to the computer processor.

4. The method of claim 1, wherein the input data is a variable defined in the business process simulation model.

5. The method of claim 1, wherein the input data is stored in a data repository communicatively coupled to the computer processor.

6. The method of claim 1, wherein each of the transactions includes a corresponding user interface.

7. The method of claim 6, wherein the user interface is displayed during execution of the transactions.

8. A system comprising:
a computer processor;
a business process modeler module executable by the computer processor, the business process modeler configured to generate a business process model including mapping business processes with activities, logical gates, and decision paths of an enterprise;
a configuration simulation view module executable by the computer processor, the configuration simulation view module configured to create a business process simulation model by assigning a transaction to each of corresponding activities for each of the business processes in the business process model, via a user interface implemented by the configuration simulation view module, the business process simulation model including at least one entry transaction and transaction sequence for each of the activities; and
a simulation engine module executable by the computer processor, the simulation engine module configured to execute the business process simulation model, the business process simulation model executed by:
calling the entry transaction and displaying the entry transaction;
loading input data and intermediate data into the business process simulation model; and
executing transactions starting with the entry transaction and using the intermediate data and an output from execution of the entry transaction to feed a next one of the transactions configured by the business process simulation model.

9. The system of claim 8, wherein the business process simulation model is further executed by triggering simulation of an activity via a token positioned at a beginning of the business process simulation model.

10. The system of claim 8, further comprising a display configured to display animation of business process simulation model execution.

11. The system of claim 8, wherein the input data is a variable defined in the business process simulation model.

12. The system of claim 8, wherein the input data is stored in a data repository communicatively coupled to the computer processor.

13. The system of claim 8, wherein each of the transactions includes a corresponding user interface, wherein the corresponding user interface displayed during execution of the transaction.

14. A computer program product comprising a computer storage medium embodied with program instructions, which when executed by a computer processor cause the computer processor to implement a method, the method comprising:
generating a business process model including mapping business processes with activities, logical gates, and decision paths of an enterprise;
creating a business process simulation model by assigning a transaction to each of corresponding activities for each of the business processes in the business process model, the business process simulation model including at least one entry transaction and transaction sequence for each of the activities;
executing the business process simulation model, comprising:
calling the entry transaction and displaying the entry transaction;
loading input data and intermediate data into the business process simulation model; and
executing transactions starting with the entry transaction and using the intermediate data and an output from execution of the entry transaction to feed a next one of the transactions configured by the business process simulation model.

15. The computer program product of claim 14, wherein executing the business process simulation model further includes triggering simulation of an activity via a token positioned at a beginning of the business process simulation model.

16. The computer program product of claim 14, wherein the method further includes displaying animation of business process simulation model execution on a display communicatively coupled to the computer processor.

17. The computer program product of claim 14, wherein the input data is a variable defined in the business process simulation model.

18. The computer program product of claim 14, wherein the input data is stored in a data repository communicatively coupled to the computer processor.

19. The computer program product of claim 14, wherein each of the transactions includes a corresponding user interface.

20. The computer program product of claim 19, wherein the user interface is displayed during execution of the transactions.
